(19) United States
(12) Patent Application Publication
(10) Pub. No.: US 2007/0148306 A1
(43) Pub. Date: Jun. 28, 2007

(54) Method of Producing and Preparing Fresh Frozen Food From Quick Frozen Vegetables and Stock

(76) Inventors: Peter H. Mattson, Foster City, CA (US); Alison Needles, Foster City, CA (US)

Correspondence Address: ROBERT M. SCHWARTZ, P.A., P.O. BOX 221470, HOLLYWOOD, FL, 33022, US

(21) Appl. No.: 11/422,118

(22) Filed: Jun. 5, 2006

Related U.S. Application Data
(60) Provisional application No. 60/687,399, filed on Jun. 3, 2005.

(51) Int. Cl. A23L 1/40

(52) U.S. Cl. 426/589

(57) ABSTRACT

A method and article for providing a frozen food wherein, particulate food matter is prepared and frozen and combined in a package with a frozen concentrated stock. The consumer prepares the food by adding a liquid that accelerates the heating of the frozen food product and the liquid accelerant, followed by heating, completes the preparation of the food product.

### INDEX TO RELATED APPLICATIONS

This application claims benefit of U.S. Provisional Patent Application Ser. No. 60/687,399 filed Jun. 3, 2005.

### BACKGROUND OF THE INVENTION

Food manufacturers are constantly looking for a new improved method of preparing foods. In particular, a rapid and efficient method, which also produces high quality foods, is always desirable. Special problems are encountered by manufacturers that desire to produce when microwave products comprising ingredients with different cooking properties. This may include, but would not be limited to soups and stews that comprise ingredients that cook at different rates. Such food products are difficult to cook and/or heat rapidly while at the same time, yielding desirable consistency of the finished product. In general, if a relatively high temperature is applied in the conventional microwaving and/or heating, often vegetables become overcooked before the seafood or meat reaches the desired temperature. This is particularly true when the products are cooked then frozen prior to processing.

The microwave is widely used to cook and/or heat food products such as frozen dinners, soups, stews, and the like mainly for its relatively shorter heating time and for simplicity of operation. In the case of heating a soup for example, the use of microwave heating alone yields undesirable result. The microwave excites water molecules, thus generating heat and water vapor. In general, food products having more than one ingredient with different cooking properties cannot be cooked and/or heated satisfactorily with microwaves alone.

With the current trend of people working outside the home, there has developed a market for foods that are prepared both, quickly and easily. Presently, consumers can purchase convenience foods from the freezer section of their grocery store to assist in the fast preparation of meals. Such meals include frozen foods that are served in sauces and frozen soups.

For example, STOUFFER'S®, part of Societe des Produits de Nestlé, S. A., of Vevey, Switzerland, makes a frozen pasta meal wherein the pasta is pre-cooked and frozen, together, in a pouch with prefrozen cubes of precooked Alfredo sauce, or some other kind of sauce. Because the sauce is prefrozen into cubes already cooked and in a condition ready for consumption, the consumer need not add anything to the pouch in order to prepare the finished food product. The consumer can prepare the meal by either boiling the unopened pouch in water or reheating the pouch in a microwave oven. During heating, the prefrozen cubes of alfredo sauce thaw and heat, along with the pasta. However, the preparation of such meal is time consuming because, if boiled, preparation of the meal requires time to boil the water and to heat the meal in the resultingly boiled water. Microwaving the pouch may take less time than boiling, but because of the way microwaves interact with ice, the melting of the frozen sauce cubes in a microwave oven still takes time.

Similarly, the consumer may purchase frozen soups from the freezer section. Such frozen soups are soups that have been fully precooked, and are then frozen. Examples of such soups can be found as made by the TABATCHNIK COMPANY. Such soups can additionally be purchased by the consumer frozen in a pouch that can be boiled or microwaved, as described above. The consumer adds nothing to the frozen product, itself, to prepare the finished food product. However, due to the process of producing such soup, wherein the soup is fully cooked prior to freezing, such soup has a tendency to have vegetables that are soft and overcooked.

Non-frozen convenience foods, for example, prepared soups from the refrigerator case of the grocery store, do not have to be thawed to be heated, but tend to have a shorter shelf life than frozen foods. Additionally, the quality of prepared soups from the refrigerator case degrades the longer the period between the time the soup is produced and the time the soup is prepared.

Canned prepared foods and soups, including foods and/or soups in jars, are additionally available to the consumer, but in order to prepare foods that are stable on the shelf without need for refrigeration, it is necessary to heat the foods at high temperatures for long periods of time. As such, foods and soups prepared in this way tend to be overcooked, with noodles and vegetables that are soft (i.e., mushy).

What is needed is a method for producing frozen food that preserves the integrity of the food, while making the food quick, yet easy, to prepare. Additionally, what is needed is a method for producing frozen food that is stable for long periods without degrading the taste of the food. What is additionally needed is a method of preparing the food by the consumer that is quicker than previous methods.

In addition, current technology provides for the sale of block frozen soup (with each block representing multiple servings) to distributors who sell the soup to individual restaurants. The soup is cooked on a stove, and the cooked product is left in a heated container. The soup could be left in the container for hours before it is served, which detrimentally affects the quality of the product. Individual servings are taken from the container until the soup in the container is used. If there is soup left over that is not served, it is discarded.

What is needed and is provided by the present invention is individual servings of soup to be sold to the restaurant in pouches. The soup is cooked in a microwave after it is ordered by the customer. The soup is served after cooking. There are no left overs that are being heated for hours, and at the end of the evening, there is no soup to be discarded.

Also, a major advantage of the invention is that it allows for home-made soup to be made in only 6 minutes. Because the present invention uses IQF vegetables, the product is being cooked for the 1st time by the consumer. All other methods of making soup, including block frozen, involve cooking the ingredients before the soups is packaged. Canned soup is cooked before it is canned. Frozen soup is cooked before it is block frozen. The present invention allows for the IQF ingredients (vegetables and seafood) to be packaged before they are cooked. The cooking by the user is the first time the ingredients are cooked, and allows for home-made soup in only 6 minutes.

There is a necessity for a method of providing a food product that can maintain the integrity of the individual particulate ingredients when present in a final prepared food product after the food product has undergone heating. The method and product must account for the varying cooking properties of the individual particulate components of a finished product.

### SUMMARY OF THE INVENTION

The invention relates to a method of producing, providing, and preparing fresh frozen food from quick frozen vegetables and stock, and more particularly, a method for producing, providing and preparing, soup made from fresh frozen food, quick frozen vegetables and stock.

In one embodiment, the method of providing a food product, comprises:
(a) preparing particulate food matter;
(b) preparing a stock;
(c) freezing the particulate food matter;
(d) freezing the stock, separate from the particulate food matter; and
(e) packaging the frozen particulate food matter with the frozen concentrated stock.

Particulate food matter refers to the individualized ingredients that comprise the finished food product.

In one embodiment, the method provides the particulate food matter is uncooked.

Alternatively, the method may provide the particulate food matter be blanched prior to freezing. In one embodiment, the stock is in a fully hydrated state. Alternatively, the method provides for concentrated stock that requires addition of water at the time of use.

In one embodiment, the method of may provide the stock be fully cooked prior to processing.

A preferred embodiment provides at least one particulate be frozen by individual quick frozen (IQF) methods that are well known in the art. The various frozen particulates must be kept at a temperature below about 32° F. during the processing and packaging of the product.

The method provides a food product to a user that is heated prior to consumption. The particulates are blanched and/or IQF prior to packaging, so there has been no actual cooking of the food product prior to use. Thus, the user's cooking will in fact, be the first time the product is actually cooked. This provides significant improvement over other methods and products. The first time cooking of the vegetables ensure they maintain their color, firmness, and overall integrity in the final cooked product.

The method may further provide a food product that comprises at least one particulate that is a primary source of protein. The particulates that are primary sources of protein may include, but would not be limited to meat, poultry, fish, and seafood. In a preferred embodiment, the particulate that is a primary source of protein is a seafood product

In one embodiment, the method provides the food product particulate that is a primary source of protein is at least partially cooked prior to packaging. Alternatively, the food product particulate that is a primary source of protein is fully cooked prior to packaging.

It is accordingly an object of the invention to provide a method of producing and preparing fresh frozen food from quick frozen vegetables and stock, which overcomes the above-mentioned disadvantages of the heretofore-known devices and methods of this general type.

A method of producing a frozen food is provided wherein, the particulate food matter is prepared, as needed, and frozen and combined in a package with a frozen concentrated stock. The consumer prepares the food by adding a liquid that accelerates the heating of the frozen food product in a microwave oven, the liquid additionally completing the food product.

In one embodiment, the method involves blanching of food ingredients. Blanching is a cooking term that describes a process of food preparation wherein the food substance is rapidly plunged into boiling water and then removed after a brief, timed interval and then plunged into iced water or placed under cold running water. Blanching rapidly heats and then cools the food. This allows the food, usually fruits and vegetables, to firm up and makes the food's natural flavour more pronounced, and is often a preparative technique for freezing food.

Blanching is also an effective method of loosening the skin on fruits or nuts that one may wish to peel, such as tomatoes, plums, peaches, or almonds.

In addition, blanching enhances the color of some (particularly green) ingredients.

Steam blanching is also used to neutralise bacteria and enzymes present in foods so that they may be processed and gain a greater shelf life, such as peanuts.

The present invention further comprises an article for providing a food product to a user comprising:
(a) at least one individually quick frozen, uncooked particulate; and
(b) a frozen stock;
wherein said article contains separate frozen stock and uncooked particulate and the first cooking of said uncooked particulate is performed by the user.

In a preferred embodiment, the frozen stock is prepared, frozen, and are divided into individually frozen solid roux cubes.

Thus the article contains individualized frozen solids.

Other features which are considered as characteristic for the invention are set forth in the appended claims.

Although the invention is illustrated and described herein as embodied in a method of producing and preparing fresh frozen food from quick frozen vegetables and stock, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWING

FIG. 1 is a flow diagram of a method of producing a fresh frozen food in accordance with one embodiment of the present invention.

FIG. 2 is a flow diagram of a method of preparing a fresh frozen food in accordance with one embodiment of the present invention.

FIG. 3 is a side perspective view of a product in accordance with one embodiment of the present invention during one step of its preparation.

FIG. 4 is a side perspective view of a product in accordance with one embodiment of the present invention during another step of its preparation.

FIG. 5 is a side perspective view of a prepared product in accordance with one embodiment of the present invention

### DETAILED DESCRIPTION OF THE PREFERRED EMBODIMENTS

The method of the present invention may be equally important for producing food products not only for home use, but on a commercial scale as well.

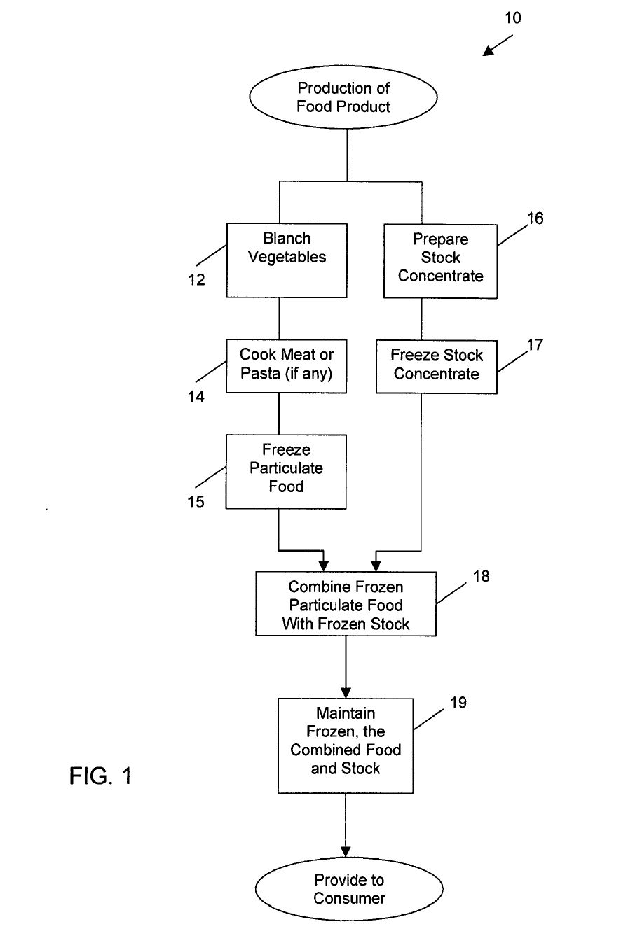

Referring now to the figures of the drawing in detail and first, particularly, to FIG. 1 thereof, there is seen a flow diagram of a method 10 for producing and providing a food product in accordance with one particular embodiment of the present invention. The food product of the method includes particulate food matter, such as vegetables, meat, seafood, clams, shrimp, fish and/or pasta, as well as non-particulate food matter, such as a sauce or broth. For example, the method 10 can be used to produce a snack or meal in sauce or to produce a soup.

As shown in FIG. 1, the particulate food matter, if desired, can be prepared in a variety of ways. Additionally, different categories of particulate food matter used in the food product can be prepared in different ways for use in the same final food product. For example, to insure that vegetables have the look and feel of fresh vegetables, as shown in step 12, vegetables for use in the finished food product can be blanched, but need not be fully cooked, contrary to what has previously been the case with, for example, frozen soups. Blanching the vegetables deactivates enzymes in the vegetables and partially cooks them, while permitting them to remain crisp and enhancing their appearance. As such, the blanched vegetables of the present invention retain the characteristics of “fresh” vegetables, as opposed to vegetables that have been cooked for long periods of times, such as with frozen soups or canned food products.

Additionally, as shown in step 14 of the method 10 of FIG. 1. If meat is used in the product, the meat, as opposed to the vegetables, could be fully cooked, in order to stabilize the meat. Optionally, any pasta used in the product could be cooked somewhere between fully and “blanched” in order to give the pasta an “al dente” texture, or could be cooked more to provide a more cooked texture, as desired. By cooking the particulate foods separately, even foods in the same category can be cooked different amounts. For example, chicken, beef, pork or lamb would be cooked differently, i.e., for a longer period of time, than clams, shrimp, fish or other seafood.

Once the particulate food matter is prepared, as appropriate for each type of food matter, the particulate food matter is frozen. Such food can be frozen in some manner, including, individually quick frozen (“IQF”) using a machine such as the FLOFREEZE® M&S FREEZER by FMC FOODTECH of Chicago, Ill.

The preparation of the non-particulate food matter, i.e., the stock, occurs in a different manner. As shown in method 10, the stock of the present invention is converted, in some percentage, to a concentrate. Stock as used in the present invention, is a liquid used as the base for soup, gravy or sauce. The stock, in the present invention, is concentrated in an amount that would require the consumer to add some further liquid to the resultant food product, in order to achieve the intended taste and consistency of the completed food product.

After the stock has been concentrated, as in step 16 of method 10, the resultant stock is frozen and subdivided into smaller units, as shown in step 17 of the method 10. For example, the concentrated stock may be frozen and cut into cubes. These cut up frozen cubes will be the base of the stock in the reconstituted product. A machine for making such frozen cubes of liquid material is currently made by FRIGOSCANDIA, part of FMC FOODTECH. Note that this is not meant to be limiting, the concentrated stock using some other means. Additionally, the desired amount of concentrated frozen stock can, optionally, be provided as a single, frozen unit for use in the product, or may be provided as multiple frozen units. Additionally, although the FRIGOSCANDIA product cuts the frozen stock into cubes, units of another shape can be used. Additionally, if desired, the concentrated stock can be divided into units, prior to freezing.

As shown in step 18 of method 10, an appropriate portion of the frozen particulate food (step 15) is combined with an appropriate portion of the frozen non-particulate food (step 17) and the two are packaged together. The frozen particulate and non-particulate food matter may be packaged in a pouch. Alternately, the frozen particulate and non-particulate food matter can be packaged in some other type of receptacle, such as a cardboard box or bowl, in which the final food product is to be made.

The packaged food product resulting from step 18 is maintained in frozen conditions (step 19) until delivered to the consumer. For example, the packaged products may be delivered in refrigerated trucks to the grocer's freezer, and then displayed in the grocer's freezer section.

Alternatively, it is contemplated that the method and the article of the present invention may be practiced without keeping the prepared article frozen. Advances in food technology have demonstrated the ability to provide vacuum-sealed food packages that do not need refrigeration. The stock cubes and IQF particulates may be combined with vacuum-sealed packaging to provide a product to the user that demonstrates all the advantages of the frozen article.

As can be seen from the foregoing, the instant invention has the advantage over other foods and soups, that the particulate food matter need not be cooked in the resultant sauce or soup, prior to freezing. Additionally, each food material need only be cooked “as needed” and need not be overcooked. This is especially advantageous in the preparation of frozen soup, and differs from all previous known methods of making frozen soup, which entail cooking all the soup ingredients together, prior to freezing. Contrary to other known frozen soups, soup made in accordance with the present invention is frozen and packaged as individual (i.e., not cooked together) particulate and non-particulate food components.

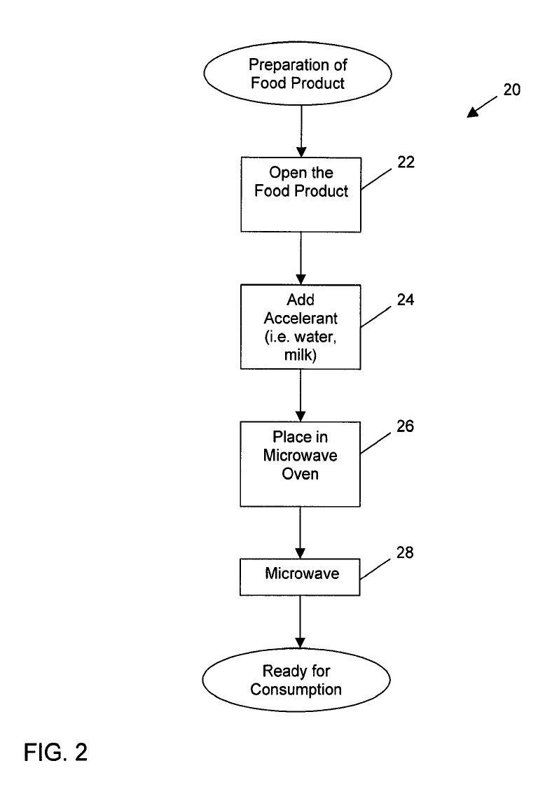

Referring now to FIG. 2, there is shown a method 20 of preparing the food product produced in accordance with the method 10 of FIG. 1. The consumer receives the frozen food product, and in accordance with instructions on it's packaging, opens or exposes the food product. Step 22. For example, if the food product is in a pouch, the pouch may be opened and poured into a bowl, shallow dish or tray. If the packaging is in a form in which the consumer can eat the product, such as a shallow tray or bowl, the consumer can just open the top of the packaging to expose the food product.

Additionally following the instructions on the packaging, the consumer adds an accelerant liquid to the frozen food product. For example, as described above in connection with FIG. 1, the stock contained in the food product has been concentrated and frozen. Microwave ovens tend to do a poor job of quickly melting ice and heating the resultant liquid. However, the addition of liquid to ice has been found to accelerate the melting of the ice. For example, when water is added to ice, the water is heated by the microwaves and resulting hot water works as an added force (in addition to the microwaves, themselves) to melt the ice. Thus, when liquid is added to ice in the microwave, two mechanisms (i.e., microwaves and the heat of the excited liquid surrounding the ice) work to melt the ice more quickly than if liquid, in its liquid state, were not present. As such, in step 24 of method 20, the consumer adds an accelerant liquid, such as milk or water, to the exposed, frozen food product. The addition of the accelerant liquid to the food product was planned for, when the stock was concentrated. As such, the addition of liquid to the food product in step 24, not only is used to accelerate the cooking time in a microwave, but also, is used to provide the intended flavor and/or consistency to the finished food product. Note that if the concentrated stock is a gravy or sauce, less liquid may be added than if the concentrated stock is for a soup.

As shown in step 26, the exposed frozen food product with the added liquid accelerant is placed into the microwave oven. The microwave oven is set, as described in the product instructions, and the food is microwaved. Step 28. When microwaving has finished and, optionally, the food has been allowed to sit an appropriate time for cooling of the pouch or container, the prepared food is ready for consumption.

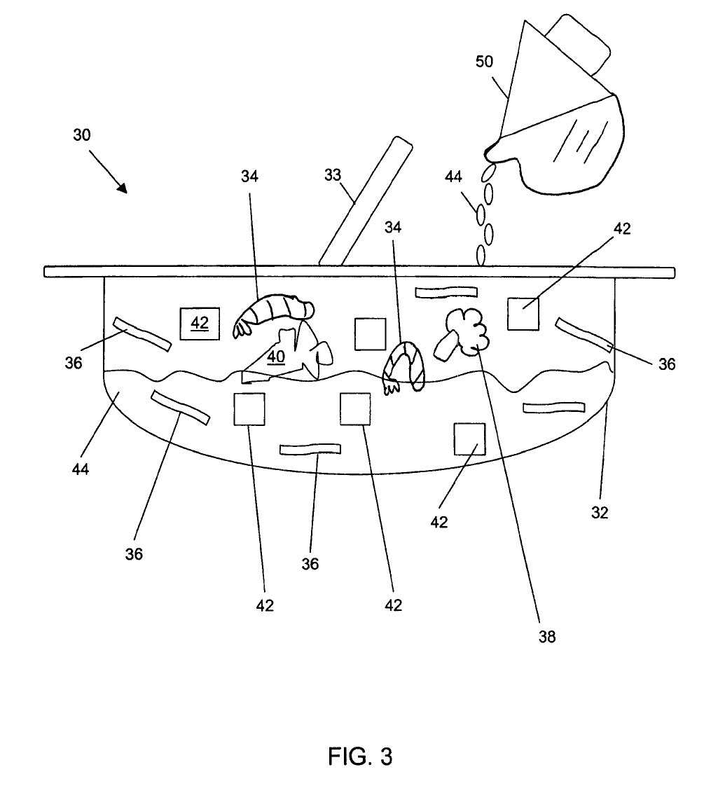

Referring now to FIGS. 3-5, there is shown a method of preparing a food product 30 in accordance with one particular embodiment of the present invention. As shown in FIG. 3, the frozen food product 30 of the present embodiment has been packaged into a microwavable bowl 32. The frozen food product 30 includes particulate food matter, such as shrimp 34, noodles 36, broccoli 38 and carrot 40. Additionally, the frozen food product 30 includes the frozen concentrated stock units (in the present embodiment, cubes) 42. The frozen concentrated stock units 42 have been prepared from the vegetables, broth, stock, flavorings, starches and/or spices necessary to restore the food or, in the present example, soup, to its intended taste and consistency.

To prepare the frozen food product 30 into the desired soup, the packaging lid 33 is peeled back to expose the frozen particulate food matter 34, 36, 38 and 40 and non-particulate food matter 42. Pursuant to the food preparation instructions, a liquid accelerant 44 is measured in the measuring cup 50 and poured over the exposed frozen particulate food matter 34, 36, 38 and 40 and non-particulate food matter 42. As noted above, the liquid accelerant 44 may be water or milk, or some other liquid accelerant. For example, in preparing a chicken, shrimp, or other noodle soup, the liquid accelerant 44 may be water. When preparing chowder, such as a clam chowder, milk will be used. It is also possible that there will be times when other suitable liquids, such as chicken broth or vegetable broth, may be used. However, in the most preferred embodiment, it is intended that the concentrated stock of the present invention will provide sufficient flavoring to the resultant food product, so that flavored broth, or other flavored accelerant, would not need to be used.

Once the liquid accelerant 44 has been added, the packaging lid 33 may be replaced over the top of the bowl 32, to increase heating and reduce splatter.

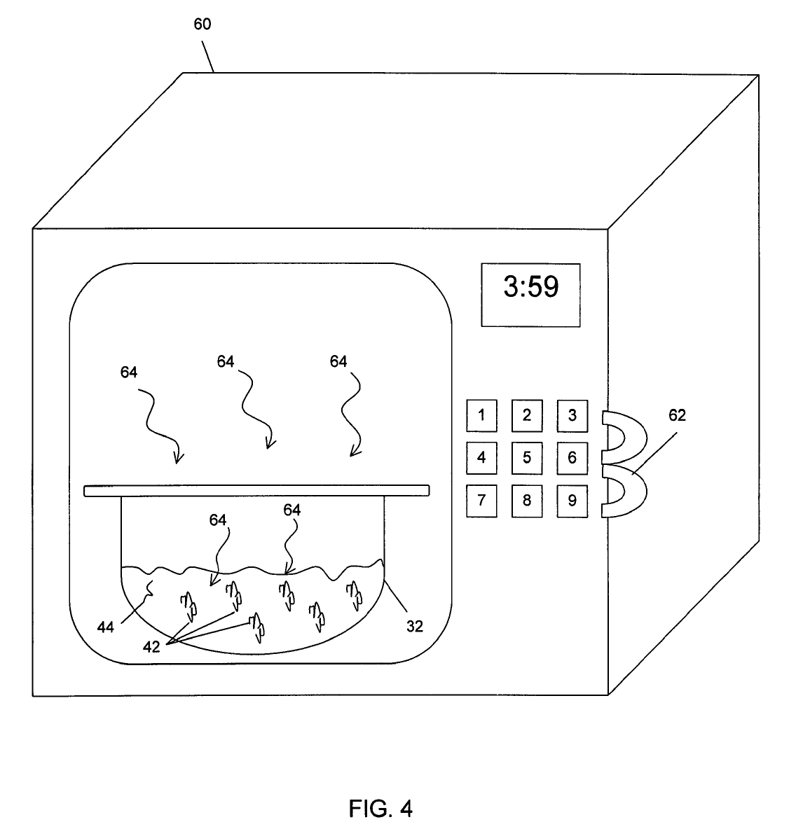

Referring now to FIG. 4, the bowl 32 is placed into a microwave 60, and the microwave is programmed according to the food product instructions, using the front panel 62 of the microwave 60. During microwave cooking, microwaves 64 impinge on the food product, heating the frozen matter, such as the frozen stock 42, as well as exciting the liquid accelerant 44. Note that the microwaves 64 serve to melt the frozen stock 42 both directly, through direct impingement, and indirectly, through excitation and/or heating of the liquid accelerant 44 contacting the frozen stock. Resultantly, the frozen particulate matter and frozen condensed stock 42 will melt much more quickly then if liquid, in its liquid state, is not present when microwave cooking is initiated.

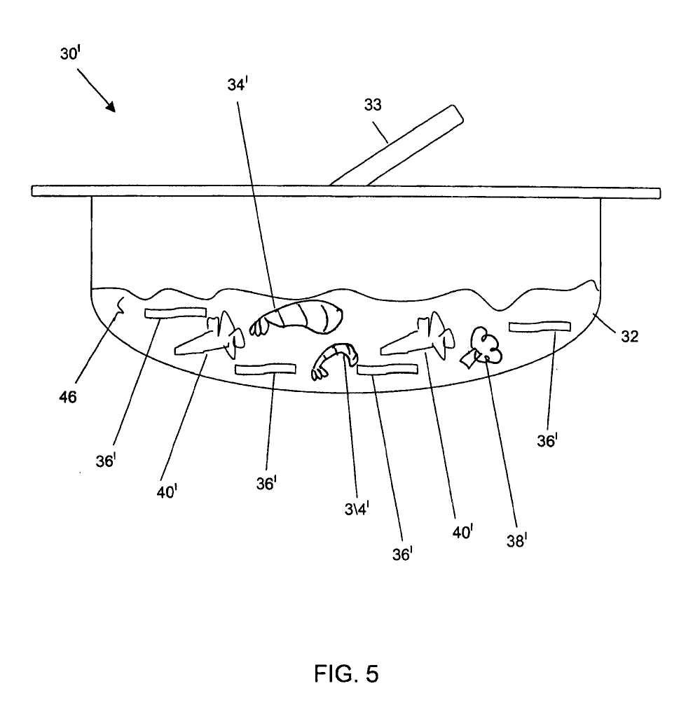

As shown in FIG. 5, the resulting product can be removed from the microwave. After microwave cooking, the microwave bowl 32 contains the cooked and heated shrimp 34′, noodles 36′, broccoli 38′ and carrot 40′ in a broth 46, formed from the combination of the liquid accelerant 44 and frozen stock 42.

The particulate matter in the finished soup 30′ is fresh, with each item of meat and vegetable maintaining its integrity and a fresh consistency and appearance, due to each ingredient only being cooked individually and/or as needed.

As such, the present invention provides an advance in food production and preparation over the state of the art in that food can be prepared more quickly and of better quality for lower production costs. It is no longer necessary to produce frozen soup by cooking all ingredients together until overcooked, and freezing the conglomerate, only to require the consumer to slowly recook the same food. The present invention cooks each ingredient, only as needed for that ingredient, and combines the frozen cooked ingredients with frozen concentrated stock to the consumer. The consumer then merely adds a liquid accelerant to the frozen product and cooks in the microwave to quickly complete the preparation of the meal.

### EXAMPLE 1

| | | Most Preferred |
|---|---|---|
| | Preferred Range | Range |
| Roux Cubes | 35-65% | 40-55% |
| ½″ diced Roasted | 5-15% | 8-12% |
| Red Potatoes, IQF | | |
| Diced Red Potatoes, IQF | 5-15% | 8-12% |
| Clams, IQF, ½″ | 10-25% | 12-20% |
| Corn, IQF | 1-12% | 2-6% |
| Celery, IQF | 1-12% | 3-8% |
| Onion, IQF | 1-12% | 2-6% |

In this example, the particulates are kept frozen while packaging. The package will provide for the method of preparing the soup, whereby the particulates are cooked for the first time by the end user. Additionally, there are no liquids placed into the packaging of the article used in the method of the present invention. The roux cubes of this example comprise water, cream, salt and spices. The roux mixture is prepared, then frozen and divided into individual cubes. Further, the subject invention provides that the IQF vegetable particulates maintain the color, texture, and quality of fresh vegetables. The arrangement of the IQF particulates in conjunction with frozen stock cubes provides an opportunity for the first instance of cooking to be by the user.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A method of providing a food product, comprising:
(a) preparing particulate food matter;
(b) preparing a stock;
(c) freezing the particulate food matter;
(d) freezing the stock, separate from the particulate food matter; and
(e) packaging the frozen particulate food matter with the frozen concentrated stock.

2. The method of claim 1 wherein said particulate food matter is uncooked.

3. The method of claim 1 wherein said particulate food matter is blanched prior to freezing.

5. The method of claim 1 wherein said stock is concentrated.

6. The method of claim 1 wherein water is added to said stock at a time close to heating said food product.

7. The method of claim 1 wherein said stock is fully cooked prior to processing.

8. The method of claim 1 wherein said freezing is by individual quick-freezing.

9. The method of claim 1 wherein said freezing is at a temperature of about 32° F.

10. The method of claim 1 wherein said packaging comprises solid particulates.

11. The method of claim 1 wherein said packaging consists of solid particulates.

12. The method of claim 1 wherein said food product is heated prior to consumption.

13. The method of claim 1 wherein said food product contains at least one uncooked component that is cooked with the entire food product prior to consumption.

14. The method of claim 1 wherein said food product comprises at least one component that is a primary source of protein.

15. The method of claim 14 wherein said food product that is a primary source of protein is selected from, meat, poultry, fish, and seafood.

16. The method of claim 15 wherein said food product comprises a component that is a primary source of protein is seafood.

17. The method of claim 15 wherein said food product component that is a primary source of protein is at least partially cooked prior to packaging.

18. The method of claim 15 wherein said food product that is a primary source of protein is fully cooked prior to packaging.

19. An article for providing a food product to a user comprising:
(a) at least one individually quick frozen, uncooked particulate; and
(b) a frozen stock;
wherein said article contains separate frozen stock and uncooked particulate and the first cooking of said uncooked particulate is performed by the user.

20. The article of claim 18, wherein said frozen stock are individually frozen solid roux cubes.

21. The article of claim 18, wherein said article contains frozen solids.
